(19) United States
(12) Patent Application Publication
(10) Pub. No.: US 2007/0070291 A1
(43) Pub. Date: Mar. 29, 2007

(54) Length-adjustable strap for glasses

(76) Inventor: Kung-Ping Su, Taipei (TW)

Correspondence Address: BRUCE H. TROXELL, SUITE 1404, 5205 LEESBURG PIKE, FALLS CHURCH, VA, 22041, US

(21) Appl. No.: 11/236,646

(22) Filed: Sep. 28, 2005

(51) Int. Cl. G02C 3/00

(52) U.S. Cl. 351/156

(57) ABSTRACT

A length-adjustable strap for glasses includes a strap body, two coupling elements connected at rear ends to two opposite ends of the strap body and at front ends to two end pieces of a pair of glasses, and a slide movably mounted on the strap body. Each of the coupling elements is made of a soft rubber material and formed at the front end with an inward tapered bore for tightly binding around the end piece of the glasses. The slide may be moved along the strap body to adjust a total length from the slide to the two opposite ends of the strap body to thereby fitly fasten the glasses to a user's head when the user is taking exercise or engaging in some game. Or, the slide may be moved reversely to loosen the strap body for the user to remove the glasses.

### FIELD OF THE INVENTION

The present invention relates to an easily operable strap for glasses, and more particularly to a length-adjustable strap for fitly fastening a pair of glasses to a user's head to prevent the glasses from falling when the user is taking exercise or engaging in some game.

### BACKGROUND OF THE INVENTION

A lot of people have poor sight due to bad reading habit, watching TV or computer screen over a long time frequently, or inheritance, and require a pair of glasses to correct the sight. The glasses tend to drop when a wearer is taking exercise or engaging in some game. Various types of straps have been developed for fastening the glasses to a wearer's head to prevent the glasses from dropping. Taiwanese patent publication No. 516647 discloses a glasses fastening assembly for use in sport. Taiwanese patent publication No. M240573 discloses an assembly of glasses frame and fastening strap. The disclosures of the above two Taiwanese patents involve glasses frame having special structures to work with a correspondingly structured fastening strap, so that the glasses are associated with the fastening strap and prevented from falling off the user's head when the user is taking exercise or engaging in a game.

The above-disclosed fastening straps are designed for using with specific sports glasses only, and could not be used with general glasses to meet most other users' need. Most commercially available glasses fastening straps include two loops put around two temples of the glasses. Taiwanese patent publication Nos. 344464, 394386, and 420313 all disclose loops or loop-like components for putting around and connecting to the temples of glasses. Such loops tend to move to and fro on the temples of glasses and fail to stably and firmly hold the glasses to the user's head, particularly when the user is taking exercise or engaging in some game, resulting in dropping of the glasses from the user's head.

### SUMMARY OF THE INVENTION

A primary object of the present invention is to provide a structurally simple strap that could be quickly and firmly connected to a pair of glasses without the risk of easily separating from the glasses.

Another object of the present invention is to provide a length-adjustable strap for fitly fastening a pair of glasses to a user's head, so that the glasses would not easily separate from the user's head when the user is taking exercise or playing some game.

A further object of the present invention is to provide a length-adjustable strap for glasses, all components of which are either made of or coated with a soft rubber material to protect a user from injuring by the strap under impact.

To achieve the above and other objects, the length-adjustable strap for glasses of the present invention includes a strap body, two coupling elements connected at front ends to two end pieces of a pair of glasses and at rear ends to two opposite ends of the strap body, and a slide movably mounted on the strap body. Each of the coupling elements is made of a soft rubber material and formed at the front end with an inward tapered bore for quickly and tightly binding around the end piece of the glasses.

The slide of the length-adjustable strap of the present invention has two parallelly arranged through holes formed thereon for the two opposite ends of the strap body to extend therethrough. The slide may be moved along the strap body to adjust a total length between the slide and the two opposite ends of the strap body, so that the strap may be tightened to fitly fasten the glasses to a user's head or loosened to enable easy removal of the glasses.

In the present invention, two plastic blocks having a relatively high rigidity are separately embedded in the rear ends of the two coupling elements for firmly gripping the two opposite ends of the strap body in the plastic blocks. The plastic blocks also enable the rear ends of the coupling elements to have a fixed shape without easily becoming deformed.

In the present invention, the slide is integrally formed from an inner layer made of a rigid plastic material, and an outer layer made of a soft rubber material to absorb any impact of the slide on the user's head.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a length-adjustable strap for glasses according to an embodiment of the present invention;

FIG. 2 is a perspective view showing a pair of glasses with the length-adjustable strap of FIG. 1 connected thereto;

FIG. 3 is an enlarged sectional view of a coupling element of the length-adjustable strap of FIG. 1;

FIG. 4 is an assembled cross-sectional view of a slide of the length-adjustable strap of FIG. 1; and

FIG. 5 is an exploded perspective view of the slide of FIG. 4.

### DETAILED DESCRIPTION OF THE PREFERRED EMBODIMENTS

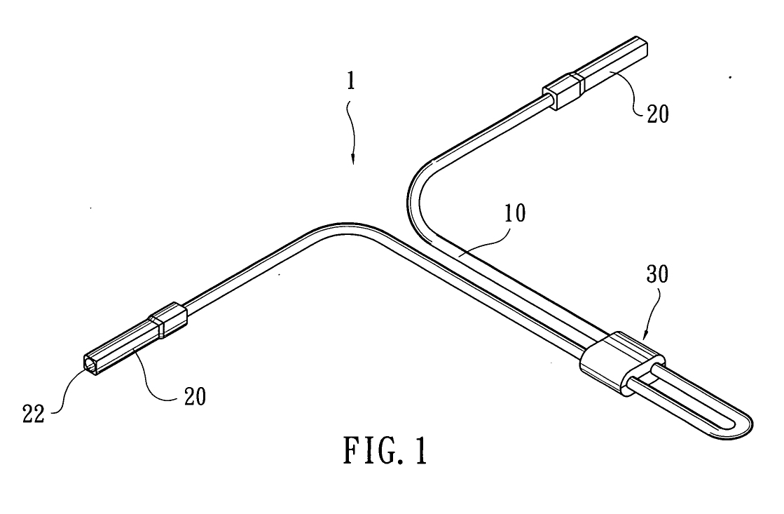

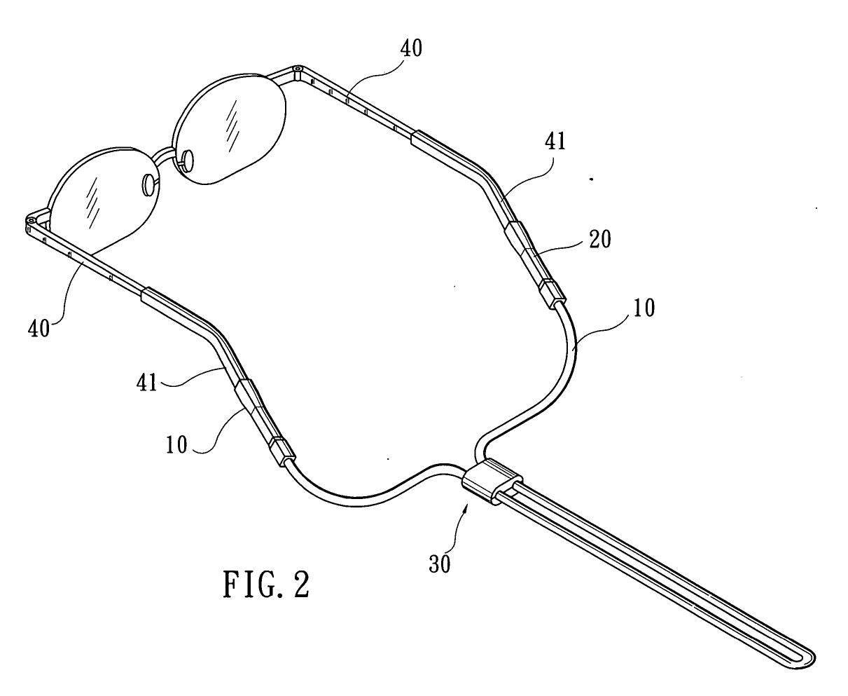

Please refer to FIGS. 1 to 4, in which a length-adjustable strap for glasses 1 according to an embodiment of the present invention is shown. As shown, the strap 1 includes a strap body 10, two coupling elements 20 separately connected at two rear ends to two opposite ends of the strap body 10, and a slide 30 movably mounted on the strap body 10. The coupling elements 20 are tubular members made of a soft rubber material and formed at a front end with an elastically expandable bore 22 each. The slide 30 includes a pair of parallelly arranged through holes 31, via which the two opposite ends of the strap body 10 are extended.

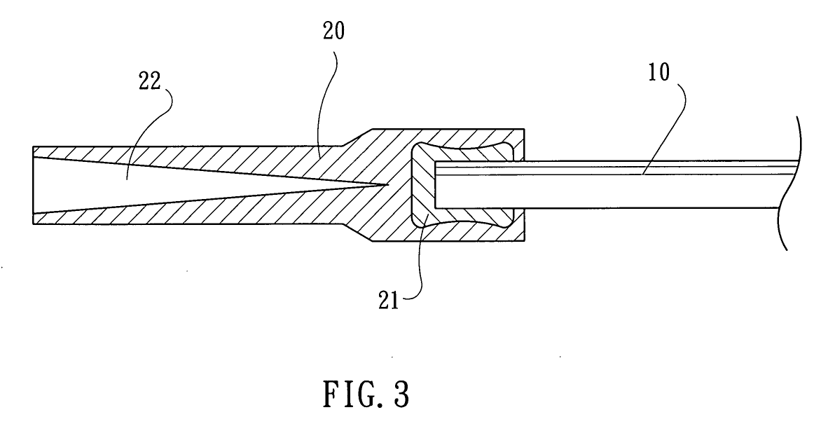

The bore 22 of each of the coupling elements 20 has an inner diameter slightly smaller than an outer diameter of an end piece 41 of a temple of glasses 40. As can be clearly seen from FIG. 3, the bore 22 of the coupling element 20 is an inward tapered bore. When the end piece 41 of the glasses 40 is extended into the coupling element 20, the tapered bore 22 of the coupling element 20 is elastically expanded and then tightly encloses the end piece 41 to thereby firmly connect one end of the strap 1 to the glasses 40. Since it is very easy to put the coupling elements 20 around the end pieces 41 of the temples of the glasses 40, the strap 1 can be quickly associated with the glasses 40 without the risk of separating therefrom easily.

The slide 30 is used to adjust a total length from the slide 30 to the two coupling elements 20, so that the strap body 10 of the strap 1 may be fitly fastened to a user's head to prevent the glasses 40 from moving. The slide 30 includes two parallelly arranged through holes 31, via which the two opposite ends of the strap body 10 are extended to connect to the rear ends of the coupling elements 20. By sliding the slide 30 on the strap body 10 to adjust the length of the strap body 10 behind the slide 30, the total length from the slide 30 to the two coupling elements 20 may be reduced or increased to enable firmly wearing of the glasses 40 on the user's head or easy removing of the glasses 40 from the user's head, respectively.

While the coupling element 20 made of a soft rubber material possess good elasticity and expandability, it does not provide sufficient grip to hold the strap body 10 thereto. To avoid the strap body 10 from easily separating from the coupling element 20, a plastic block 21 having a relatively high rigidity is embedded in the rear end of the coupling element 20 to form an integral part of the coupling element 20, as shown in FIG. 3. Since both the rubber material, which is mainly butadiene rubber, and the plastic material, which is mainly polyethylene or polypropylene, are alkenyl compounds which are mutually combinable, it is possible for the plastic block 21 and the rubber-made coupling element 20 to form an integral body after the plastic block 21 is embedded in the rear end of the coupling element 20. Each of the two opposite ends of the strap body 10 is embedded in the plastic block 21 and tightly gripped thereto, so that the strap body 10 is firmly connected at two ends to the coupling elements 20 without the risk of easily loosening therefrom. The soft rubber portion of the coupling element 20 is formed by injection molding to enclose the plastic block 21, ensuring the soft rubber portion of the coupling element 20 and the rigid plastic block 21 to form an integral body. With the rigid plastic block 21, the coupling element 20 is not subject to deformation and could firmly hold the strap body 10 thereto.

While the two through holes 31 on the slide 30 allow the strap body 10 to extend therethrough, they must also produce a compressing force against the strap body 10, so that the strap body 10 does not easily move relative to the slide 30 after the slide 30 has been adjusted to a desired position on the strap body 10. For this purpose, the two through holes 31 formed on the slide 30 have an inner diameter slightly smaller than an outer diameter of the strap body 10 in a normal loose state, so as to produce a clamping force against the strap body 10 extended therethrough.

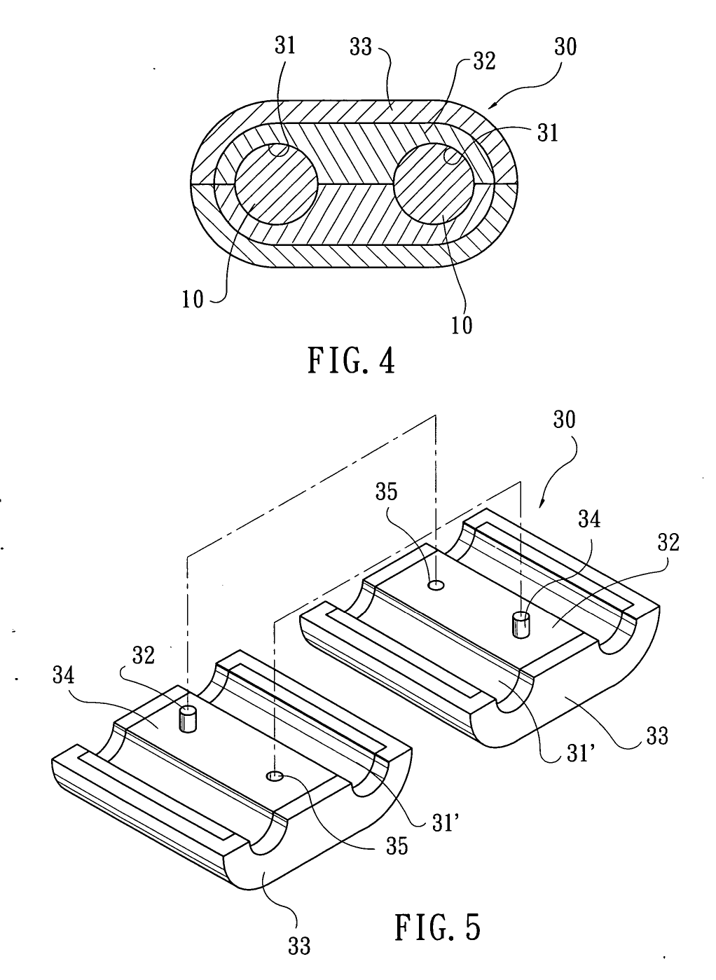

Please refer to FIG. 4. When the length-adjustable strap for glasses 1 is in use, the slide 30 is normally located at the back of head and tends to be forced against the head under collision of the user's head with something. It is therefore very important for the slide 30 to produce proper clamping force against the strap body 10 and to avoid injuring the user's head at the same time. For this purpose, the slide 30 is integrally formed from an inner layer 32 made of a rigid plastic material, on which the two through holes 31 are formed to have fixed inner diameter and smooth inner wall surface to facilitate moving of the strap body 10 therein, and an outer layer 33 made of a soft rubber material adapted to absorb an impact of the slide 30 against the user's head.

Please refer to FIG. 5. The slide 30 is formed from two halves having a pair of semicircular recesses 31′ each. When the two halves are closed to each other to form a complete slide 30, the two pairs of semicircular recesses 31′ together form the two through holes 31. To connect the slide 30 to the strap body 10, first position two opposite sections of the strap body 10 in the two semicircular recesses 31′ on a first one of the two halves, and then close the other half onto the first half to enclose the strap body 10 in the two through holes 31. To enable easy alignment of the two halves of the slide 30 with each other, two sets of pin 34 and bore 35 are correspondingly provided on an inner side of the two halves of the slide 30, such that the pins 34 on the two halves are tightly fitted in the bores 35 when the two halves are closed to each other. The pins 34 and the bores 35 may be further applied with bonding agent to ensure firm and lasting engagement of the two halves of the slide 30 with each other.

To use the length-adjustable strap for glasses 1, first force the end pieces 41 of the temples of the glasses 40 into the tapered bores 22 of the two coupling elements 20, so that the coupling elements 20 elastically tightly hold the end pieces 41 to connect the strap body 10 to the glasses 40. Then, wear the glasses 40 with the strap body 10 located behind the user's head, and rearward pull the portion of the strap body 10 behind the slide 30 to thereby force the slide 30 forward to finally bear against the back of the user's head. At this point, the strap 1 is fitly fastened around the user's head and the glasses 40 are stably and comfortably held to the user's face without the risk of dropping due to impact.

The length-adjustable strap for glasses according to the present invention may be used with any type of glasses, and has simple structure for easy and quick connection to the glasses. The strap for glasses of the present invention can be easily operated to ensure stable and comfortable holding of glasses to the user's face without the risk of dropping due to impact, and can therefore ensure the safety of glasses when the user is taking exercise or engaging in some game.

What is claimed is:

1. A length-adjustable strap for glasses, comprising a strap body, two coupling elements connected at rear ends to two opposite ends of said strap body, and a slide provided on said strap body;
each of said coupling elements being a tubular member made of a soft rubber material and having an elastically expandable bore formed at a front end thereof; said coupling elements being connected at said front ends to end pieces of two temples of a pair of glasses, such that said elastically expandable bores tightly enclose said end pieces to firmly connect said two opposite ends of said strap body to said glasses; and
said slide being movably mounted on said strap body to enable adjustment of a total length from said slide to said two opposite ends of said strap body, such that said strap body may be fitly fastened to a user's head behind said glasses; and
a plastic block having a relatively high rigidity being embedded in said rear end of each said coupling element to form an integral part of said coupling element, and said strap body being firmly connected to said coupling elements by embedding said two opposite ends in said rigid plastic blocks.

2. The length-adjustable strap for glasses as claimed in claim 1, wherein said elastically expandable bore formed at said front end of each said coupling element is an inward tapered bore.

3. The length-adjustable strap for glasses as claimed in claim 1, wherein said slide is integrally formed from an inner layer made of a rigid plastic material, and an outer layer made of a soft rubber material.

4. The length-adjustable strap for glasses as claimed in claim 1, wherein said slide includes two parallelly arranged through holes, via which said two opposite ends of said strap body are extended.
